(19) United States
(12) Patent Application Publication
(10) Pub. No.: US 2020/0270393 A1
(43) Pub. Date: Aug. 27, 2020

(54) HARDENER COMPOSITION

(71) Applicant: SABIC GLOBAL TECHNOLOGIES B.V., Bergen op Zoom (NL)

(72) Inventor: Edwards Norman Peters, Selkirk, NY (US)

(21) Appl. No.: 16/634,623

(22) PCT Filed: Sep. 27, 2018
(86) PCT No.: PCT/US2018/053080

§ 371 Date: Jan. 28, 2020

Related U.S. Application Data
(60) Provisional application No. 62/568,472, filed on Oct. 5, 2017.

(51) Int. Cl. C08G 59/42; C08G 59/24

(52) U.S. Cl. CPC C08G 59/4284; C08G 59/4269; C08G 2101/00; C08G 59/245; C08G 59/4238

(57) ABSTRACT

A hardener composition for epoxy resins includes a dianhydride and one or both of a monoanhydride and a hydroxyl-diterminated poly(phenylene ether). The hardener components can be blended in the substantial absence of solvent to yield a homogeneous composition having a reduced glass transition temperature or melting point that facilitates reduced-temperature blending of the hardener composition with the epoxy resin.

### CROSS-REFERENCE TO RELATED APPLICATIONS

This application is a National Stage application of PCT/US/18/053080, filed Sep. 27, 2018, which claims the benefit of U.S. Provisional Application No. 62/568,472, filed Oct. 5, 2017, both of which are incorporated by reference herein in their entirety.

### BACKGROUND

Dianhydrides are useful hardeners for epoxy resins. However, their high melting points make it difficult to form a homogeneous blend of dianhydride and epoxy resin without heating at such a high temperature that the two components react. While it is possible to use a solvent to facilitate blending of dianhydride and epoxy resin, solvent use adds complexity, expense, and environmental burden. There is therefore a need for a substantially solvent-free dianhydride-containing hardener that can be blended with epoxy resin at a temperature significantly lower than that required to blend dianhydride and epoxy resin alone.

### BRIEF SUMMARY

One embodiment is a hardener composition comprising, based on the total weight of the hardener composition: 5 to 95 weight percent of a dianhydride having structure (1)

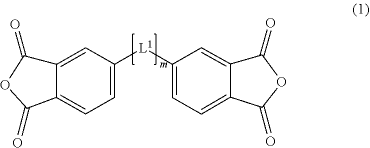

wherein m is 0 or 1, and L¹ is unsubstituted or substituted C₁-C₂₀ hydrocarbylene; and 5 to 95 weight percent of a monoanhydride having structure (2)

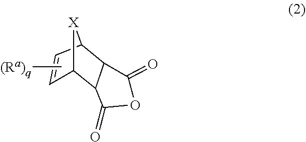

wherein q is zero or 1, R^{a} is C₁-6-alkyl, and X is —CH₂—, —(CH₂)₂—, —O—, or —S—, or a hydroxyl-diterminated poly(phenylene ether) having an intrinsic viscosity of 0.03 to 0.2 deciliter per gram measured by Ubbelohde viscometer at 25° C. in chloroform, or a combination of the anhydride having structure (2) and the hydroxyl-diterminated poly(phenylene ether); wherein the hardener composition is homogeneous as evidenced by a single glass transition temperature or a single melting point in the range −80 to +200° C. as determined by differential scanning calorimetry using a heating rate of 20° C./minute; and wherein the hardener composition comprises zero to 1 weight percent total of solvents for one or more of the dianhydride having structure (1), the monoanhydride having structure (2), and the hydroxyl-diterminated poly(phenylene ether).

This and other embodiments are described in detail below.

### DETAILED DESCRIPTION

The present inventor has determined that a homogeneous, amorphous blend can be prepared from a crystalline dianhydride and either or both of a monoanhydride and a phenylene ether oligomer. The homogeneity of the blend is evidenced by a single glass transition temperature that can be at or below ambient temperature. When the blend is prepared from crystalline dianhydride and a phenylene ether oligomer, no significant reaction occurs between the two components as the blend is formed. And when the blend is prepared from crystalline dianhydride and a crystalline monoanhydride, the blend is amorphous, exhibiting no melting point. In addition, three-component homogeneous amorphous blends can be prepared from crystalline dianhydride, monoanhydride, and phenylene ether oligomer. All of these binary and ternary amorphous mixtures of hardeners can readily be blended with epoxy resins without the use of high temperatures. And curable compositions containing the present hardener composition and an epoxy resin yield a cured composition with a very high glass transition temperature. These elevated glass transition temperatures can be comparable to those provided by higher-cost blends of multi-functional epoxy resins and anhydride hardeners.

One embodiment is a hardener composition comprising, based on the total weight of the hardener composition: 5 to 95 weight percent of a dianhydride having structure (1)

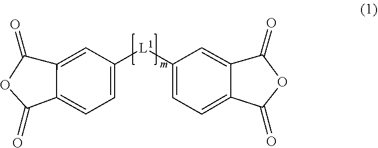

wherein m is 0 or 1, and L¹ is unsubstituted or substituted C₁-C₂₀ hydrocarbylene; and 5 to 95 weight percent of a monoanhydride having structure (2)

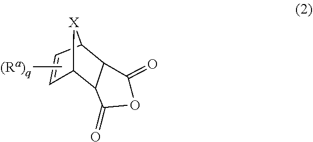

wherein q is zero or 1, R^{a} is C₁₋₆-alkyl, and X is —CH₂—, —(CH₂)₂—, —O—, or —S—, or a hydroxyl-diterminated poly(phenylene ether) having an intrinsic viscosity of 0.03 to 0.2 deciliter per gram measured by Ubbelohde viscometer at 25° C. in chloroform, or a combination of the anhydride having structure (2) and the hydroxyl-diterminated poly(phenylene ether); wherein the hardener composition is homogeneous as evidenced by a single glass transition temperature or a single melting point in the range −80 to +200° C. as determined by differential scanning calorimetry using a heating rate of 20° C./minute; and wherein the hardener composition comprises zero to 1 weight percent total of solvents for one or more of the dianhydride having structure (1), the monoanhydride having structure (2), and the hydroxyl-diterminated poly(phenylene ether).

The hardener composition requires a dianhydride having structure (1).

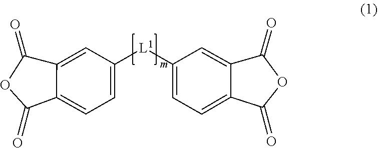

wherein m is 0 or 1, and L¹ is unsubstituted or substituted C₁-C₂₀ hydrocarbylene. As used herein, the term “hydrocarbyl”, whether used by itself, or as a prefix, suffix, or fragment of another term, refers to a residue that contains only carbon and hydrogen unless it is specifically identified as “substituted hydrocarbyl”. The hydrocarbyl residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. When the hydrocarbyl residue is described as substituted, it can contain heteroatoms in addition to carbon and hydrogen. When m is zero, a single bond joins the two phthalic anhydride groups. In other embodiments of dianhydride structure (1), m is 1, and L¹ is

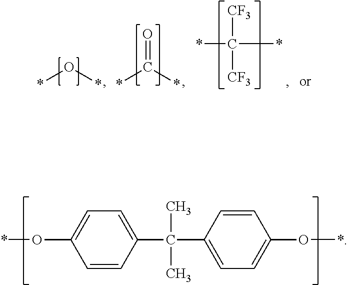

In a very specific embodiment, m is 1 and L¹ is

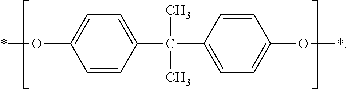

The hardener composition comprises the dianhydride having structure (1) in an amount of 5 to 95 weight percent, based on the total weight of the hardener composition. Within this range, the dianhydride amount can be 10 to 90 weight percent, or 20 to 80 weight percent, or 30 to 70 weight percent, or 30 to 50 weight percent, or 30 to 40 weight percent.

In addition to the dianhydride having structure (1), the hardener composition comprises the monoanhydride having structure (2), or the hydroxyl-diterminated poly(phenylene ether), or the combination of the monoanhydride having structure (2) and the hydroxyl-diterminated poly(phenylene ether).

In some embodiments, the hardener composition comprises the monoanhydride having structure (2)

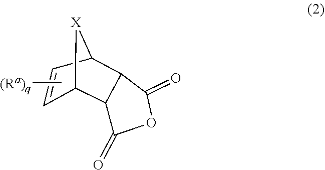

wherein q is zero or 1, R^{a} is C₁₋₆-alkyl, and X is —CH₂—, —(CH₂)₂—, —O—, or —S—. In some embodiments, q is 1. When R^{a} is present (i.e., when q is 1), the R^{a} substituent can be attached to the 1, 4, 5, 6, or 7 position of the norbomene skeleton. Position numbering is shown below.

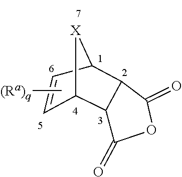

It will be understood that when R^{a} is attached to the 7 position, X is —CH₂— or —(CH₂)₂—, and R^{a} replaces one of the hydrogen atoms of —CH₂— or —(CH₂)₂—.

The monoanhydride having structure (2) can be exo or endo, or a mixture of exo and endo. In some embodiments, it is endo. Structures of exo and endo anhydrides are shown below.

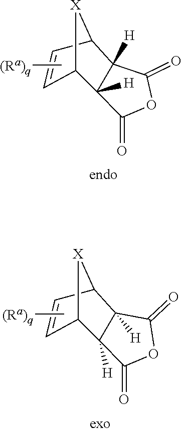

Specific monoanhydrides having structure (2) include 5-norbomene-2,3-dicarboxylic anhydride, methyl-5-norbornene-2,3-dicarboxylic anhydride, ethyl-5-norbomene-2,3-dicarboxylic anhydride, propyl-5-norbomene-2,3-dicarboxylic anhydride, iso-propyl-5-norbomene-2,3-dicarboxylic anhydride, butyl-5-norbomene-2,3-dicarboxylic anhydride, sec-butyl-5-norbomene-2,3-dicarboxylic anhydride, tert-butyl-5-norbomene-2,3-dicarboxylic anhydride, pentyl-5-norbomene-2,3-dicarboxylic anhydride, neo-pentyl-5-norbomene-2,3-dicarboxylic anhydride, hexyl-5-norbomene-2,3-dicarboxylic anhydride, cyclohexyl-5-norbomene-2,3-dicarboxylic anhydride, and combinations thereof. In a very specific embodiment, of the monoanhydride having structure (2), q is 1, R^{a} is methyl, and X is —CH₂—.

In some embodiments, the hardener composition comprises the hydroxyl-diterminated poly(phenylene ether). The term “hydroxyl-diterminated” means that the poly(phenylene ether) has, on average, 1.5 to 2.5, or 1.8 to 2.2, phenolic hydroxyl groups per molecule. The hydroxyl-diterminated poly(phenylene ether) has an intrinsic viscosity of 0.03 to 0.2 deciliter per gram, measured by Ubbelohde viscometer at 25° C. in chloroform. Within this range, the intrinsic viscosity can be 0.04 to 0.17 deciliter per gram, or 0.05 to 0.15 deciliter per gram.

In some embodiments, the hydroxyl-diterminated poly(phenylene ether) has the structure

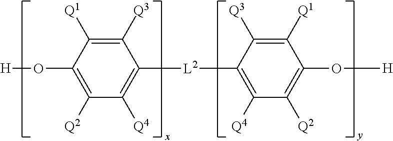

wherein each occurrence of Q¹ and Q² is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q³ and Q⁴ is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; x and y are independently 0 to 30, or 0 to 20, or 0 to 15, or 0 to 10, or 0 to 8, provided that the sum of x and y is at least 2, or at least 3, or at least 4; and L² has the structure

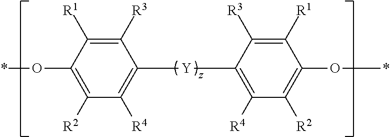

wherein each occurrence of R¹ and R² and R³ and R⁴ is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; z is 0 or 1; and Y is selected from the group consisting of

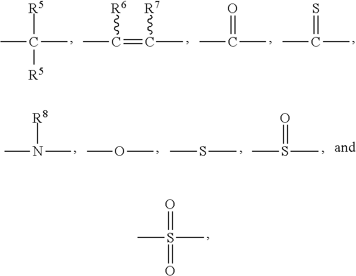

wherein each occurrence of R⁵-R⁸ is independently hydrogen, C₁-C₁₂ hydrocarbyl, or C₁-C₆ hydrocarbylene wherein the two occurrences of R⁵ collectively form a C₄-C₁₂ alkylene group.

In some embodiments, the hydroxyl-diterminated poly(phenylene ether) comprises a copolymer of 2,6-xylenol and 2,2-bis(3,5-dimethyl-4-hydroxyphenyl)propane having the structure

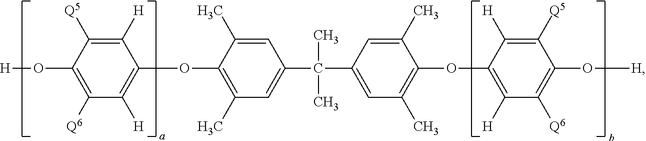

wherein each occurrence of Q⁵ and Q⁶ is independently methyl or di-n-butylaminomethyl; and each occurrence of a and b is independently 0 to about 20, provided that the sum of a and b is at least 2, or at least 3, or at least 4. Hydroxyl-diterminated poly(phenylene ether) having this structure can be synthesized by oxidative copolymerization of 2,6-xylenol and 2,2-bis(3,5-dimethyl-4-hydroxyphenyl)propane in the presence of a catalyst comprising di-n-butylamine.

In some embodiments, the hardener composition comprises the monoanhydride having structure (2) and the hydroxyl-diterminated poly(phenylene ether).

The hardener composition comprises the monoanhydride having structure (2), or the hydroxyl-diterminated poly(phenylene ether), or the combination thereof in an amount of 5 to 95 weight percent, based on the total weight of the hardener composition. Within this range, the amount of the monoanhydride having structure (2), or the hydroxyl-diterminated poly(phenylene ether), or the combination thereof can be 10 to 90 weight percent, or 20 to 80 weight percent, or 30 to 80 weight percent, or 50 to 80 weight percent, or 60 to 80 weight percent.

The hardener composition can, optionally, include a curing promoter for epoxy resin. As used herein, the term “curing promoter” refers to a compound that promotes or catalyzes the epoxy curing reaction without reacting stoichiometrically with the epoxy resin. Curing promoters for epoxy resin include, for example, triethylamine, tributylamine, dimethylaniline, diethylaniline, α-methylbenzyldimethylamine, N,N-dimethylaminoethanol, N,N-dimethylaminocresol, tri(N,N-dimethylaminomethyl)phenol, 2-methylimidazole, 2-ethylimidazole, 2-laurylimidazole, 2-heptadecylimidazole, 2-phenylimidazole, 4-methylimidazole, 4-ethylimidazole, 4-laurylimidazole, 4-heptadecylimidazole, 2-phenyl-4-methylimidazole, 2-phenyl-4-hydroxymethylimidazole, 2-ethyl-4-methylimidazole, 2-ethyl-4-hydroxymethylimidazole, 1-cyanoethyl-4-methylimidazole, 2-phenyl-4,5-dihydroxymethylimidazole, and combinations thereof. When present, the curing promoter can be used in an amount of 0.005 to 1 weight percent, specifically 0.01 to 0.5 weight percent, based on the total weight of the composition.

The hardener composition comprises zero to 1 weight percent total of solvents for one or more of the dianhydride having structure (1), the monoanhydride having structure (2), and the hydroxyl-diterminated poly(phenylene ether). In some embodiments, the hardener composition excludes solvents.

In some embodiments, the hardener composition comprises 99 to 100 weight percent total of the dianhydride having structure (1), the monoanhydride having structure (2), and the hydroxyl-diterminated poly(phenylene ether).

In some embodiments, the hardener composition excludes epoxy resin.

The hardener composition is homogeneous. This homogeneity is evidenced by a single glass transition temperature or a single melting point in the range −80 to +200° C., as determined by differential scanning calorimetry using a heating rate of 20° C./minute. Also, melting points and or glass transition temperature for the individual components are not observed. Many of the hardener compositions are liquids at or near ambient temperature, greatly facilitating their blending with epoxy resins. Conditions for preparing the hardener composition are illustrated in the working examples below. In general, the hardener composition can be prepared by blending the components at a temperature below the melting point of the dianhydride.

In a very specific embodiment of the hardener composition, m is 1, and L¹ is

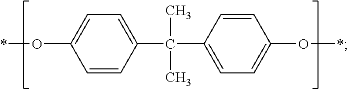

q is 1, R^{a} is methyl, and X is —CH₂—; the hydroxyl-diterminated poly(phenylene ether) comprises a copolymer of 2,6-xylenol and 2,2-bis(3,5-dimethyl-4-hydroxyphenyl)propane; the hardener composition comprises 99 to 100 weight percent total of the dianhydride having structure (1), the monoanhydride having structure (2), and the hydroxyl-diterminated poly(phenylene ether); the hardener composition comprises 20 to 60 weight percent of the dianhydride having structure (1), 20 to 60 weight percent of the monoanhydride having structure (2), and 20 to 60 weight percent of the hydroxyl-diterminated poly(phenylene ether); and the hardener composition excludes epoxy resin. Within these component amount ranges, the hardener composition can comprise 25 to 50 weight percent of the dianhydride having structure (1), 25 to 50 weight percent of the monoanhydride having structure (2), and 25 to 50 weight percent of the hydroxyl-diterminated poly(phenylene ether); or 30 to 40 weight percent of the dianhydride having structure (1), 30 to 40 weight percent of the monoanhydride having structure (2), and 30 to 40 weight percent of the hydroxyl-diterminated poly(phenylene ether).

In another very specific embodiment of the hardener composition, m is 1, and L¹ is

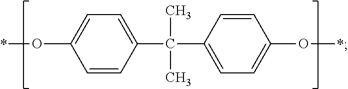

the hydroxyl-diterminated poly(phenylene ether) comprises a copolymer of 2,6-xylenol and 2,2-bis(3,5-dimethyl-4-hydroxyphenyl)propane; the hardener composition comprises 99 to 100 weight percent total of the dianhydride having structure (1) and the hydroxyl-diterminated poly(phenylene ether); the hardener composition comprises 25 to 75 weight percent of the dianhydride having structure (1), and 25 to 75 weight percent of the hydroxyl-diterminated poly(phenylene ether); and the hardener composition excludes epoxy resin. Within these component amount ranges, the hardener composition can comprise 40 to 60 weight percent of the dianhydride having structure (1), and 40 to 60 weight percent of the hydroxyl-diterminated poly(phenylene ether);

In another very specific embodiment of the hardener composition, m is 1, and L¹ is

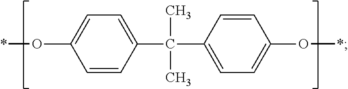

q is 1, R^{a} is methyl, and X is —CH₂—; the hardener composition comprises 99 to 100 weight percent total of the dianhydride having structure (1) and the monoanhydride having structure (2); the hardener composition comprises 20 to 80 weight percent of the dianhydride having structure (1), and 20 to 80 weight percent of the monoanhydride having structure (2); and the hardener composition excludes epoxy resin. Within these component amount ranges, the hardener composition can comprise 30 to 70 weight percent of the dianhydride having structure (1), and 30 to 70 weight percent of the monoanhydride having structure (2).

The hardener composition of the present disclosure can be used in the preparation of curable compositions. Thus a curable composition represents another aspect of the present disclosure. The curable composition comprises the hardener composition and an epoxy resin.

Suitable epoxy resins can be produced by reaction of phenols or polyphenols with epichlorohydrin to form polyglycidyl ethers. Examples of useful phenols for production of epoxy resins include substituted bisphenol A, bisphenol F, hydroquinone, resorcinol, tris-(4-hydroxyphenyl)methane, and novolac resins derived from phenol or o-cresol. Epoxy resins can also be produced by reaction of aromatic amines, such as p-aminophenol or methylenedianiline, with epichlorohydrin to form polyglycidyl amines.

A cured composition (also referred to as a thermoset composition) is obtained by heating the curable composition defined herein for a time and temperature sufficient to effect curing. For example, the curable composition can be heated to a temperature of 50-250° C. to cure the composition and provide the thermoset composition. The cured composition can also be referred to as a thermoset composition. In curing, a cross-linked, three-dimensional polymer network is formed. In some embodiments, curing the composition can include injecting the curable composition into a mold, and curing the injected composition at 150-250° C. in the mold.

The thermoset composition can have one or more desirable properties. For example, the thermoset composition can have a glass transition temperature of greater than or equal to 180° C., preferably greater than or equal to 190° C., more preferably greater than or equal to 200° C.

The curable composition described herein can also be particularly well suited for use in forming various articles. For example, useful articles can be in the form of a composite, a foam, a fiber, a layer, a coating, an encapsulant, an adhesive, a sealant, a molded component, a prepreg, a casing, a laminate, a metal clad laminate, an electronic composite, a structural composite, or a combination comprising at least one of the foregoing. In some embodiments, the article can be in the form of a composite that can be used in a variety of applications.

The invention includes at least the following aspects.

Aspect 1: A hardener composition comprising, based on the total weight of the hardener composition: 5 to 95 weight percent of a dianhydride having structure (1)

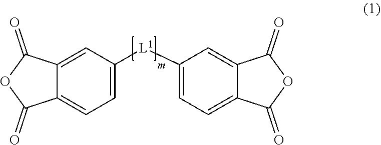

wherein m is 0 or 1, and L¹ is unsubstituted or substituted C₁-C₂₀ hydrocarbylene; and 5 to 95 weight percent of a monoanhydride having structure (2)

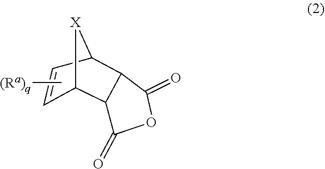

wherein q is zero or 1, R^{a} is C₁₋₆-alkyl, and X is —CH₂—, —(CH₂)₂—, —O—, or —S—, or a hydroxyl-diterminated poly(phenylene ether) having an intrinsic viscosity of 0.03 to 0.2 deciliter per gram measured by Ubbelohde viscometer at 25° C. in chloroform, or a combination of the anhydride having structure (2) and the hydroxyl-diterminated poly(phenylene ether); wherein the hardener composition is homogeneous as evidenced by a single glass transition temperature or a single melting point in the range −80 to +200° C. as determined by differential scanning calorimetry using a heating rate of 20° C./minute; and wherein the hardener composition comprises zero to 1 weight percent total of solvents for one or more of the dianhydride having structure (1), the monoanhydride having structure (2), and the hydroxyl-diterminated poly(phenylene ether).

Aspect 2: The hardener composition of aspect 1, wherein m is 1, and L is

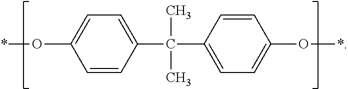

Aspect 3: The hardener composition of aspect 1 or 2, comprising the monoanhydride having structure (2).

Aspect 4: The hardener composition of aspect 1 or 2, comprising the hydroxyl-diterminated poly(phenylene ether).

Aspect 5: The hardener composition of aspect 1 or 2, comprising the monoanhydride having structure (2) and the hydroxyl-diterminated poly(phenylene ether).

Aspect 6: The hardener composition of aspect 3 or 5, wherein q is 1.

Aspect 7: The hardener composition of aspect 3 or 5, wherein the monoanhydride having structure (2) is 5-norbomene-2,3-dicarboxylic anhydride, methyl-5-norbomene-2,3-dicarboxylic anhydride, ethyl-5-norbornene-2,3-dicarboxylic anhydride, propyl-5-norbomene-2,3-dicarboxylic anhydride, iso-propyl-5-norbomene-2,3-dicarboxylic anhydride, butyl-5-norbomene-2,3-dicarboxylic anhydride, sec-butyl-5-norbomene-2,3-dicarboxylic anhydride, tert-butyl-5-norbomene-2,3-dicarboxylic anhydride, pentyl-5-norbomene-2,3-dicarboxylic anhydride, neo-pentyl-5-norbomene-2,3-dicarboxylic anhydride, hexyl-5-norbomene-2,3-dicarboxylic anhydride, cyclohexyl-5-norbomene-2,3-dicarboxylic anhydride, or combinations thereof.

Aspect 8: The hardener composition of aspect 3 or 5, wherein q is 1, R^{a} is methyl, and X is —CH₂—.

Aspect 9: The hardener composition of aspect 4 or 5, wherein the hydroxyl-diterminated poly(phenylene ether) has the structure

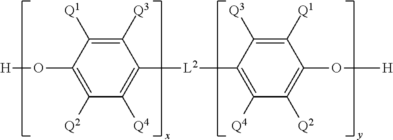

wherein each occurrence of Q¹ and Q² is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q³ and Q⁴ is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; x and y are independently 0 to 30, or 0 to 20, or 0 to 15, or 0 to 10, or 0 to 8, provided that the sum of x and y is at least 2, or at least 3, or at least 4; and L² has the structure

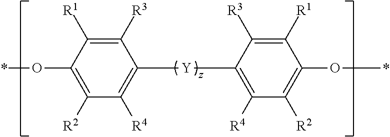

wherein each occurrence of R¹ and R² and R³ and R⁴ is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y is

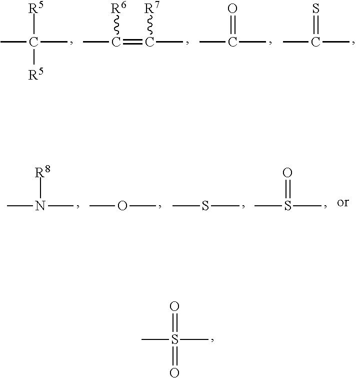

wherein each occurrence of R⁵-R⁸ is independently hydrogen, C₁-C₁₂ hydrocarbyl, or C₁-C₆ hydrocarbylene wherein the two occurrence of R⁵ collectively form a C₄-C₁₂ alkylene group.

Aspect 10: The hardener composition of aspect 4 or 5, wherein the hydroxyl-diterminated poly(phenylene ether) comprises a copolymer of 2,6-xylenol and 2,2-bis(3,5-dimethyl-4-hydroxyphenyl)propane.

Aspect 11: The hardener composition of any one of aspects 1-10, further comprising 0.005 to 1 weight percent of a curing promoter for epoxy resin.

Aspect 12: The hardener composition of any one of aspects 1-11, comprising 99 to 100 weight percent total of the dianhydride having structure (1), the monoanhydride having structure (2), and the hydroxyl-diterminated poly(phenylene ether).

Aspect 13: The hardener composition of any one of aspects 1-12, excluding epoxy resin.

Aspect 14: The hardener composition of aspect 1, wherein m is 1, and L¹ is

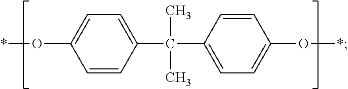

q is 1, R^{a} is methyl, and X is —CH₂—; the hydroxyl-diterminated poly(phenylene ether) comprises a copolymer of 2,6-xylenol and 2,2-bis(3,5-dimethyl-4-hydroxyphenyl)propane; the hardener composition comprises 99 to 100 weight percent total of the dianhydride having structure (1), the monoanhydride having structure (2), and the hydroxyl-diterminated poly(phenylene ether); the hardener composition comprises 20 to 60 weight percent of the dianhydride having structure (1), 20 to 60 weight percent of the monoanhydride having structure (2), and 20 to 60 weight percent of the hydroxyl-diterminated poly(phenylene ether); and the hardener composition excludes epoxy resin.

Aspect 15: The hardener composition of aspect 1, wherein m is 1, and L¹ is

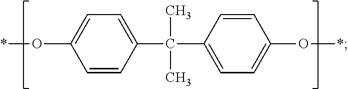

the hydroxyl-diterminated poly(phenylene ether) comprises a copolymer of 2,6-xylenol and 2,2-bis(3,5-dimethyl-4-hydroxyphenyl)propane; the hardener composition comprises 99 to 100 weight percent total of the dianhydride having structure (1) and the hydroxyl-diterminated poly(phenylene ether); the hardener composition comprises 25 to 75 weight percent of the dianhydride having structure (1), and 25 to 75 weight percent of the hydroxyl-diterminated poly(phenylene ether); and the hardener composition excludes epoxy resin.

Aspect 16: The hardener composition of aspect 1, wherein m is 1, and L¹ is

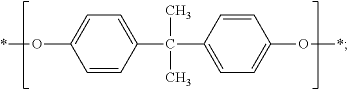

q is 1, R^{a} is methyl, and X is —CH₂—; the hardener composition comprises 99 to 100 weight percent total of the dianhydride having structure (1) and the monoanhydride having structure (2); the hardener composition comprises 20 to 80 weight percent of the dianhydride having structure (1), and 20 to 80 weight percent of the monoanhydride having structure (2); and the hardener composition excludes epoxy resin.

Aspect 17: A curable composition comprising an epoxy resin and the hardener composition of any one of aspects 1-16.

Aspect 18: A cured composition comprising a cured product of the composition of aspect 17.

Aspect 19: An article comprising the cured composition of aspect 18.

Aspect 20: The article of aspect 19, wherein the article is in the form of a composite, a foam, a fiber, a layer, a coating, an encapsulant, an adhesive, a sealant, a molded component, a prepreg, a casing, or a combination thereof.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### WORKING EXAMPLES

Components used in the working examples are summarized in Table 1.

TABLE 1

| Component | Description |
|---|---|
| BPA-DA | 4,4′-(4,4′-isopropylidenediphenoxy)bis(phthalic anhydride), CAS Reg. No. |
| | 38103-06-9; having a melting point of 184-187° C. and a molecular weight |
| | of 520.49; obtained from SABIC. |
| NMA | Methyl-5-norbornene-2,3-dicarboxylic anhydride, CAS Reg. No. |
| | 25134-21-8; obtained from Sigma-Aldrich. |
| NADIC | cis-5-Norbornene-endo-2,3-dicarboxylic anhydride, CAS Reg. No. |
| | 129-64-6; obtained from Sigma-Aldrich. |
| PPE-2OH 0.06 | Copolymer of 2,2-bis(3,5-dimethyl-4-hydroxyl)propane and |
| | 2,6-dimethylphenol, CAS Reg. No. 1012321-47-9, the copolymer having an |
| | average of about 2 hydroxyl groups per molecule, a hydroxyl equivalent |
| | weight of about 681 grams/equivalent, a glass transition temperature of |
| | about 100° C., and an intrinsic viscosity of about 0.06 deciliter per gram |
| | measured by Ubbelohde viscometer at 25° C. in chloroform; preparable |
| | according to the procedure of Example 1 of U.S. Pat. No. 8,053,077 to |
| | Braidwood et al., issued Nov. 8, 2011. |
| PPE-2OH 0.09 | Copolymer of 2,2-bis(3,5-dimethyl-4-hydroxyl)propane and 2,6- |
| | dimethylphenol, CAS Reg. No. 1012321-47-9, the copolymer having an |
| | average of about 2 hydroxyl groups per molecule, a hydroxyl equivalent |
| | weight of about 872 grams/equivalent, a glass transition temperature of |
| | about 150° C., and an intrinsic viscosity of about 0.09 deciliter per gram |
| | measured by Ubbelohde viscometer at 25° C. in chloroform; obtained as |
| | PPO ™ SA90 Resin from SABIC. |
| PPE-2OH 0.12 | Copolymer of 2,2-bis(3,5-dimethyl-4-hydroxyl)propane and 2,6- |
| | dimethylphenol, CAS Reg. No. 1012321-47-9, the copolymer having an |
| | average of about 2 hydroxyl groups per molecule, a hydroxyl equivalent |
| | weight of about 1597 grams/equivalent, a glass transition temperature of |
| | about 170° C., and an intrinsic viscosity of about 0.12 deciliter per gram |
| | measured by Ubbelohde viscometer at 25° C. in chloroform; preparable |
| | according to the procedure of Example 3 of U.S. Pat. No. 8,053,077 to |
| | Braidwood et al., issued Nov. 8, 2011. |
| 1-MeI | 1-Methylimidazole; CAS Reg. No. 616-47-7; obtained from Sigma-Aldrich. |
| BPA DGE | Diglycidyl ether of bisphenol A, CAS Reg. No. 25068-38-6, with an epoxy |
| | equivalent weight of 173 grams/equivalent, available as D.E.R. ™ 332 Resin |
| | from Dow Chemical. |

### Examples 1-4, Comparative Examples A and B

These examples illustrate blends of hydroxyl-diterminated poly(phenylene ether) (PPE-2OH) and 4,4′-(4,4′-isopropylidenediphenoxy)bis(phthalic anhydride) (bisphenol A dianhydride or BPA-DA).

Homogeneous mixtures were prepared by heating PPE-2OH and BPA-DA with stirring. The temperature was increased to 160° C. After the components were completely dissolved and stirred to ensure a homogeneous blend, the material was cooled to ambient temperature (23° C.). Samples were evaluated by differential scanning calorimetry (DSC) using a heating rate of 20° C./minute and a temperature range of −80 to 200° C. The single glass transition temperature (T_{g}) observed for each of Examples 1-4 indicates a homogeneous amorphous material Comparative Example A showed a melting temperature (Tm) of 185° C. for BPA-DA. Comparative Example B showed a T_{g} of 150° C. for PPE-20H 0.09. Results are summarized in Table 2.

TABLE 2

| | BPA- | PPE-2OH | PPE-2OH | PPE-2OH | | |
|---|---|---|---|---|---|---|
| | DA | 0.09 | 0.06 | 0.12 | Tₘ | T_{g} |
| | (g) | (g) | (g) | (g) | (° C.) | (° C.) |
| Comp. | 25.0 | 0 | 0 | 0 | 185 | ND* |
| Example A | | | | | | |
| Comp. | 0 | 25.0 | 0 | 0 | ND | 150 |
| Example B | | | | | | |
| Example 1 | 25.0 | 25.0 | 0 | 0 | ND | 75 |
| Example 2 | 25.0 | 0 | 25.0 | 0 | ND | 54 |
| Example 3 | 25.0 | 0 | 0 | 25.0 | ND | 82 |
| Example 4 | 12.5 | 37.5 | 0 | 0 | ND | 61 |

*ND = not detected

Proton nuclear magnetic resonance spectroscopy (¹H NMR) analysis of Examples 1-4 revealed no significant reaction between PPE-2OH and BPA-DA. Any reaction of PPE-2OH with BPA-DA was determined by NMR by following the concentration of hydroxyl groups (phenolic end group). The average number of hydroxyl groups in the reaction mixture was determined by functionalization with a phosphorus reagent and analysis by ³¹P NMR as described in P. Chan, D. S. Argyropoulos, D. M. White, G. W. Yeager, and A. S. Hay, Macromolecules, 1994, volume 27, pages 6371-6375.

### Examples 5-18, Comparative Example C

These examples illustrate blends of BPA-DA and methyl-5-norbomene-2,3-dicarboxylic anhydride (NMA).

Homogeneous amorphous blends were prepared by adding BPA-DA into NMA with heating and stirring at a temperature that did not exceed 150° C. After the BPA-DA was completely dissolved, the material was cooled to ambient temperature and analyzed. Over the compositional range studied, Examples 5-18 each exhibited a single glass transition temperature and no melting point. Comparative Example C (NMA) exhibited a T_{g} of −47.8° C. Results are summarized in Table 3 for various concentrations of BPA-DA in NMA. Viscosities, expressed in units of centipoise (cPs), were measured using a Brookfield digital spindle viscometer, Model DV-II, equipped with a Thermosel System for elevated temperature testing. The procedure in the viscometer's Manufacturing Operation Manual No. m/85-160-G was followed. Samples were placed in the disposable Spindle/Chambers assemble and the temperature was adjusted to the test temperature (25° C.). After equilibration for 5 minutes at the test temperature, the viscosity was determined. Results are presented in Table 3.

TABLE 3

| | BPA-DA | NMA | T_{g} | Tₘ | Viscosity |
|---|---|---|---|---|---|
| | (wt %) | (wt %) | (° C.) | (° C.) | (cPs) |
| Comp. Example C | 0 | 100 | −47.5 | ND | 380 |
| Example 5 | 5 | 95 | −45.2 | ND | 615 |
| Example 6 | 10 | 90 | −42.4 | ND | 1015 |
| Example 7 | 15 | 85 | −39.0 | ND | 1765 |
| Example 8 | 20 | 80 | −35.4 | ND | 3325 |
| Example 9 | 30 | 70 | −27.0 | ND | 15,100 |
| Example 10 | 35 | 65 | −21.8 | ND | 37,000 |
| Example 11 | 40 | 60 | −17.3 | ND | 102,000 |
| Example 12 | 45 | 55 | −12.3 | ND | 317,000 |
| Example 13 | 50 | 50 | −7.2 | ND | 987,000 |
| Example 14 | 60 | 40 | 2.0 | ND | —* |
| Example 15 | 70 | 30 | 12.5 | ND | —* |
| Example 16 | 75 | 25 | 17.7 | ND | —* |
| Example 17 | 80 | 20 | 23.8 | ND | —* |
| Example 18 | 90 | 10 | 45.3 | ND | —* |

*Viscosity greater than or equal to 1,000,000 cPs.

### Examples 19-21

These examples illustrate three-component blends of BPA-DA, NMA, and PPE-2OH 0.09. The blends were prepared by heating NMA to 150° C. and adding the BPA-DA and PPE-20H 0.09 with stirring. After the BPA-DA and PPE-2OH 0.09 were completely dissolved, the blend was cooled to ambient temperature and analyzed. Over the compositional range studied, Examples 19-21 exhibited a single glass transition temperature. Compositions and results are presented in Table 4, where “wt %” is weight percent based on the total weight of the composition.

TABLE 4

| | BPA-DA | PPE-2OH | NMA | Tₘ | T_{g} |
|---|---|---|---|---|---|
| | (wt %) | (wt %) | (wt %) | (° C.) | (° C.) |
| Example 19 | 25 | 25 | 50 | ND | 15 |
| Example 20 | 40 | 12.5 | 47.5 | ND | 11 |
| Example 21 | 32.5 | 25 | 42.5 | ND | 18 |

### Examples 22-27, Comparative Example D

These examples illustrate blends of BPA-DA and NADIC. Blends were prepared by melting the NADIC (at around 166 to 170° C.) and adding the BPA-DA with stirring. After the BPA-DA was completely dissolved, the material was cooled to ambient temperature and analyzed. Samples were evaluated by differential scanning calorimetry (DSC) using a heating rate of 20° C./minute and a temperature range of −80 to 200° C. Over the compositional range studied, Examples 22-27 exhibited a single melting point as shown in Table 5. The results suggest that BPA-DA and NADIC have formed a eutectic.

TABLE 5

| | BPA-DA | NADIC | Tₘ |
|---|---|---|---|
| | (wt %) | (wt %) | (° C.) |
| Comparative | 0 | 100 | 166 |
| Example D | | | |
| Example 22 | 10 | 90 | 98 |
| Example 23 | 20 | 80 | 90 |
| Example 24 | 40 | 60 | 87 |
| Example 25 | 60 | 40 | 89 |
| Example 26 | 70 | 30 | 77 |
| Example 27 | 80 | 20 | 78 |

### Examples 28-33, Comparative Example E

These examples illustrate the use of BPA-DA/NMA blends as hardeners for the epoxy resin bisphenol A diglycidyl ether (BPA DGE). Examples 28-33 were prepared by dissolving BPA-DA/NMA blends in BPA DGE, where the BPA-DA/NMA blends were from Examples 9, 11, 13, 14, 15, and 17, respectively. Curing catalyst, 1-Methylimidazole (1-MeI) was added and dissolved in the homogeneous mixture. Samples were placed in an oven at 120° C. After 30 minutes the temperature was increased to 150° C. After an additional 30 minutes the temperature was increased to 175° C. After an additional 30 minutes the temperature was increased to 200° C. After an additional 30 minutes the temperature was increased to 220° C. After an additional 60 minutes the oven was turned off and the cured samples were allowed to cool overnight in the oven. Samples were evaluated by DSC using a heating rate of 20° C./minute and a temperature range of 30 to 275° C. In addition, the samples were evaluated by Thermogravimetric Analysis (TGA) in nitrogen and air using a heating rate of 20° C./minute and a temperature range of 30 to 900° C. Data are summarized in Table 6.

The results show that the glass transition temperature value and the amount of char increase with increasing levels of BPA-DA. Increased char suggests that there is less fuel or volatile material being produced during pyrolysis. Less fuel production suggest increase resistance to burning.

TABLE 6

| | | | Anhydride Blend | | | | | | | | | |
|---|---|---|---|---|---|---|---|---|---|---|---|---|
| | | | Compositions | | | | | | | | | |
| | BPA- | | | BPA- | | | | | | | | |
| | DA/NMA | Source of | NMA in | DA in | | | | | Char in N2 | Char in N2 | Char in N2 | Char in air |
| | Blend | BPA/NMA | Blend | Blend | NMA | BPA DGE | 1-MeI | Tg | at 700° C. | at 800° C. | at 900° C. | at 700° C. |
| | (g) | Blend | (g) | (g) | (g) | (g) | (g) | (° C.) | (%) | (%) | (%) | (%) |
| C. Ex. E | 0 | — | 0 | 0 | 15.22 | 34.78 | 0.5 | 170 | 23.7 | 22.15 | 21.1 | 12.91 |
| Ex. 28 | 17.63 | Ex. 9 | 12.34 | 5.29 | — | 32.37 | 0.5 | 184 | 24.7 | 22.97 | 22.2 | 14.14 |
| Ex. 29 | 18.63 | Ex. 11 | 11.18 | 7.45 | — | 31.37 | 0.5 | 190 | 25.09 | 23.45 | 22.6 | 15.89 |
| Ex. 30 | 19.74 | Ex. 13 | 9.87 | 9.87 | — | 30.27 | 0.5 | 196 | 25.88 | 24.45 | 23.6 | 18.72 |
| Ex. 31 | 20.97 | Ex. 14 | 8.29 | 12.58 | — | 29.03 | 0.5 | 202 | 27.21 | 25.71 | 24.8 | 21.47 |
| Ex. 32 | 22.38 | Ex. 15 | 6.71 | 15.67 | — | 27.62 | 0.5 | 210 | 28.85 | 27.19 | 26.2 | 27.74 |
| Ex. 33 | 24.00 | Ex. 17 | 4.8 | 19.2 | — | 26.00 | 0.5 | 224 | 30.83 | 28.96 | 27.82 | 28.10 |

### Examples 34 and 35, Comparative Example F

These examples illustrate the use of blends of BPA-DA, NMA, and PPE-20H 0.09 as hardeners for the epoxy resin bisphenol A diglycidyl ether (BPA DGE). Comparative Example F was prepared by dissolving PPE-20H 0.09 in NMA at 120-150° C. The homogeneous mixture was cooled below 100° C. and the BPA DGE was added and stirred. After thorough mixing 1-MeI was added, stirred, and dissolved. Examples 34 and 35 were prepared by first preparing the homogeneous blends of BPA-DA, NMA, and PPE-20H 0.09 following the procedure for Examples 19-21. The three-component blend was cooled below 100° C., and the BPA DGE was added and stirred. After thorough mixing, the 1-MeI was added, stirred, and dissolved. Samples of Comparative Example F and Examples 34-35 were placed in an oven at 120° C. After 30 minutes the temperature was increased to 150° C. After an additional 30 minutes the temperature was increased to 175° C. After an additional 30 minutes the temperature was increased to 200° C. After an additional 30 minutes the temperature was increased to 220° C. After an additional 60 minutes the oven was turned off and the cured samples were allowed to cool overnight in the oven. Samples were evaluated by DSC using a heating rate of 20° C./minute and a temperature range of 30 to 275° C. Compositions and DSC results are presented in Table 7. Glass transition temperature increases with increasing levels of the three component hardeners.

TABLE 7

| | | | PPE-2OH | | | |
|---|---|---|---|---|---|---|
| | NMA | BPA-DA | 0.09 | BPA DGE | 1-MeI | T_{g} |
| | (g) | (g) | (g) | (g) | (g) | (° C.) |
| C. Ex. F | 12.3 | 0 | 7.7 | 30.00 | 0.50 | 178 |
| Ex. 34 | 9.8 | 5.0 | 7.2 | 27.95 | 0.50 | 188 |
| Ex. 35 | 8.1 | 8.1 | 7.4 | 26.48 | 0.50 | 202 |

### Examples 36 and 37, Comparative Example G

This example illustrates the use of homogeneous blends of BPA-DA and NMA as hardeners for the epoxy resin BPA DGE.

Comparative Example G was prepared by mixing NMA and BPA DGE. A 20 gram sample was taken for viscosity measurements. To the remaining material, the catalyst was added and dissolved. The resulting homogeneous mixtures were poured into preheated molds and placed in an oven at 120° C.

Examples 36 and 37 were prepared by dissolving BPA-DA in NMA as described in Examples 9-17. The temperature of the BPA-DA/NMA blend was lowered below 100° C. and the DGE BPA was added with stirring. Samples (20 grams) were taken for viscosity measurements. To the remaining material, the catalyst was added and dissolved. The homogeneous mixtures were poured into preheated molds and placed in an oven at 120° C.

Comparative Example G, and Examples 36 and 37 were cured with an initial temperature of 120° C. for 60 minutes, then the temperature was increased to 150° C. After 30 minutes the temperature was increased to 175° C. After an additional 30 minutes the temperature was increased to 200° C. After an additional 60 minutes the oven was turned off and the cured samples were allowed to cool overnight in the oven. Samples were evaluated by DSC using a heating rate of 20° C./minute and a temperature range of 30 to 275° C.

Viscosities, expressed in units of cPs (centipoise), were measured as described for Examples 5-18, except that the test temperature were varied (25, 50, or 70° C.).

Compositions and results are summarized in Table 8. Glass transition temperature increases with increasing levels of BPA-DA.

TABLE 8

| | Preblended | | | | | Viscosity, | Viscosity, | Viscosity, |
|---|---|---|---|---|---|---|---|---|
| | NMA | BPA-DA | BPA DGE | 1-MeI | T_{g} | 25° C. | 50° C. | 70° C. |
| | (g) | (g) | (g) | (g) | (° C.) | (cPs) | (cPs) | (cPs) |
| C. Example G | 60.89 | 0 | 139.11 | 1.00 | 170 | 2245 | 205 | 55 |
| Example 36 | 39.47 | 39.47 | 121.07 | 1.00 | 195 | 36,750 | 1385 | 225 |
| Example 37 | 22.77 | 70.21 | 107.02 | 0.60 | 208 | 688,000 | 14,700 | 1,100 |

1. A hardener composition comprising, based on the total weight of the hardener composition:
5 to 95 weight percent of a dianhydride having structure (1) 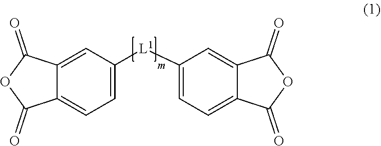
wherein m is 0 or 1, and L¹ is unsubstituted or substituted C₁-C₂₀ hydrocarbylene; and
5 to 95 weight percent of
a monoanhydride having structure (2) 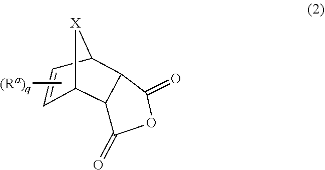
wherein q is zero or 1, R^{a} is C₁₋₆-alkyl, and X is —CH₂—, —(CH₂)₂—, —O—, or —S—, or
a hydroxyl-diterminated poly(phenylene ether) having an intrinsic viscosity of 0.03 to 0.2 deciliter per gram measured by Ubbelohde viscometer at 25° C. in chloroform, or
a combination of the anhydride having structure (2) and the hydroxyl-diterminated poly(phenylene ether);
wherein the hardener composition is homogeneous as evidenced by a single glass transition temperature or a single melting point in the range −80 to +200° C., as determined by differential scanning calorimetry using a heating rate of 20° C./minute; and
wherein the hardener composition comprises zero to 1 weight percent total of solvents for one or more of the dianhydride having structure (1), the monoanhydride having structure (2), and the hydroxyl-diterminated poly(phenylene ether).

2. The hardener composition of claim 1, wherein m is 1, and L¹ is

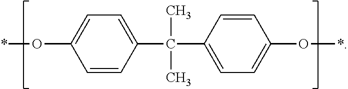

3. The hardener composition of claim 1, comprising the monoanhydride having structure (2).

4. The hardener composition of claim 1, comprising the hydroxyl-diterminated poly(phenylene ether).

5. The hardener composition of claim 1, comprising the monoanhydride having structure (2) and the hydroxyl-diterminated poly(phenylene ether).

6. The hardener composition of claim 3, wherein q is 1.

7. The hardener composition of claim 3, wherein the monoanhydride having structure (2) is 5-norbomene-2,3-dicarboxylic anhydride, methyl-5-norbornene-2,3-dicarboxylic anhydride, ethyl-5-norbornene-2,3-dicarboxylic anhydride, propyl-5-norbomene-2,3-dicarboxylic anhydride, iso-propyl-5-norbomene-2,3-dicarboxylic anhydride, butyl-5-norbomene-2,3-dicarboxylic anhydride, sec-butyl-5-norbomene-2,3-dicarboxylic anhydride, tert-butyl-5-norbomene-2,3-dicarboxylic anhydride, pentyl-5-norbomene-2,3-dicarboxylic anhydride, neo-pentyl-5-norbomene-2,3-dicarboxylic anhydride, hexyl-5-norbornene-2,3-dicarboxylic anhydride, cyclohexyl-5-norbomene-2,3-dicarboxylic anhydride, or combinations thereof.

8. The hardener composition of claim 3, wherein q is 1, R^{a} is methyl, and X is —CH₂—.

9. The hardener composition of claim 4, wherein the hydroxyl-diterminated poly(phenylene ether) has the structure 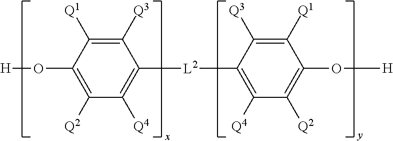
wherein each occurrence of Q¹ and Q² is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q³ and Q⁴ is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; x and y are independently 0 to 30, or 0 to 20, or 0 to 15, or 0 to 10, or 0 to 8, provided that the sum of x and y is at least 2, or at least 3, or at least 4; and L² has the structure 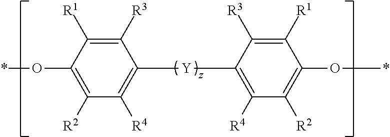
wherein each occurrence of R¹ and R² and R³ and R⁴ is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y is 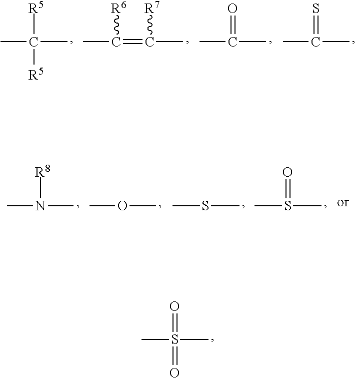
wherein each occurrence of R⁵-R⁸ is independently hydrogen, C₁-C₁₂ hydrocarbyl, or C₁-C₆ hydrocarbylene wherein the two occurrence of R⁵ collectively form a C₄-C₁₂ alkylene group.

10. The hardener composition of claim 4, wherein the hydroxyl-diterminated poly(phenylene ether) comprises a copolymer of 2,6-xylenol and 2,2-bis(3,5-dimethyl-4-hydroxyphenyl)propane.

11. The hardener composition of claim 1, further comprising 0.005 to 1 weight percent of a curing promoter for epoxy resin.

12. The hardener composition of claim 1, comprising 99 to 100 weight percent total of the dianhydride having structure (1), the monoanhydride having structure (2), and the hydroxyl-diterminated poly(phenylene ether).

13. The hardener composition of claim 1, excluding epoxy resin.

14. The hardener composition of claim 1, wherein
m is 1, and L¹ is 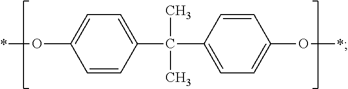
q is 1, R^{a} is methyl, and X is —CH₂—;
the hydroxyl-diterminated poly(phenylene ether) comprises a copolymer of 2,6-xylenol and 2,2-bis(3,5-dimethyl-4-hydroxyphenyl)propane;
the hardener composition comprises 99 to 100 weight percent total of the dianhydride having structure (1), the monoanhydride having structure (2), and the hydroxyl-diterminated poly(phenylene ether);
the hardener composition comprises
20 to 60 weight percent of the dianhydride having structure (1),
20 to 60 weight percent of the monoanhydride having structure (2), and
20 to 60 weight percent of the hydroxyl-diterminated poly(phenylene ether); and
the hardener composition excludes epoxy resin.

15. The hardener composition of claim 1, wherein
m is 1, and L¹ is 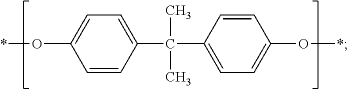
the hydroxyl-diterminated poly(phenylene ether) comprises a copolymer of 2,6-xylenol and 2,2-bis(3,5-dimethyl-4-hydroxyphenyl)propane;
the hardener composition comprises 99 to 100 weight percent total of the dianhydride having structure (1) and the hydroxyl-diterminated poly(phenylene ether);
the hardener composition comprises
25 to 75 weight percent of the dianhydride having structure (1), and
25 to 75 weight percent of the hydroxyl-diterminated poly(phenylene ether); and
the hardener composition excludes epoxy resin.

16. The hardener composition of claim 1, wherein
m is 1, and L¹ is 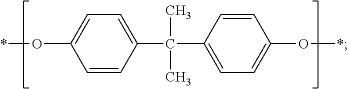
q is 1, R^{a} is methyl, and X is —CH₂—;
the hardener composition comprises 99 to 100 weight percent total of the dianhydride having structure (1) and the monoanhydride having structure (2);
the hardener composition comprises
20 to 80 weight percent of the dianhydride having structure (1), and
20 to 80 weight percent of the monoanhydride having structure (2); and
the hardener composition excludes epoxy resin.

17. A curable composition comprising an epoxy resin and the hardener composition of claim

18. A cured composition comprising a cured product of the composition of claim 17.

19. An article comprising the cured composition of claim 18.

20. The article of claim 19, wherein the article is in the form of a composite, a foam, a fiber, a layer, a coating, an encapsulant, an adhesive, a sealant, a molded component, a prepreg, a casing, or a combination thereof.
